(19) United States
(12) Patent Application Publication
(10) Pub. No.: US 2018/0254156 A1
(43) Pub. Date: Sep. 6, 2018

(54) LUMINOUS KEYBOARD

(71) Applicant: Primax Electronics Ltd., Taipei (TW)

(72) Inventor: CHE-WEI YANG, Taipei (TW)

(21) Appl. No.: 15/651,797

(22) Filed: Jul. 17, 2017

(30) Foreign Application Priority Data
Mar. 3, 2017 (TW) 106107024

(51) Int. Cl. H01H 13/83; H01H 13/705; H01H 3/12

(52) U.S. Cl. CPC H01H 13/83; H01H 3/125; H01H 13/705

(57) ABSTRACT

The present invention provides a luminous keyboard, including a key, a ring-shaped shading element, and a light source. The ring-shaped shading element is disposed between the key and the light source and is configured to shade light generated by the light source. When the key is pressed down, the key presses down the ring-shaped shading element and enables the ring-shaped shading element to be deformed, so as to prevent the ring-shaped shading element from affecting strokes of the key.

### FIELD OF THE INVENTION

The present invention relates to a luminous keyboard, and in particular, to a luminous keyboard having a ring-shaped shading element.

### BACKGROUND OF THE INVENTION

To enable a user to conveniently use a keyboard in a place lacking in light, a luminous keyboard is launched in a market. A light source is disposed inside the luminous keyboard to illuminate keys, so that characters or symbols on the keys are easy to be recognized.

Referring to FIG. 1, FIG. 1 is a schematic diagram of a conventional luminous keyboard. As shown in FIG. 1, the conventional luminous keyboard 10 includes a plurality of keys 11 (FIG. 1 merely shows one key 11), a deckle board 12, a switch circuit board 13, a baseboard 14, and a light source 15. Each key 11 includes a keycap 16, a support element 17, and an elastic body 18, and the deckle board 12 has a plurality of openings 121. The deckle board 12, the switch circuit board 13, the baseboard 14, and the light source 15 are sequentially disposed below the keycap 16 from top to bottom.

More specifically, one end of the support element 17 of the key 11 is connected to the keycap 16, and the other end of the support element 17 of the key 11 penetrates through an opening 121 of the deckle board 12 to be connected to a hook of the baseboard 14. Therefore, the keycap 16 is fixed on the baseboard 14 by means of the support element 17. When the keycap 16 is pressed down, the keycap 16 moves towards the deckle board 12 and presses down the elastic body 18, so that the elastic body 18 is deformed and triggers the switch circuit board 13 to generate a switch signal. When the keycap 16 is not pressed down, the elastic body 18 helps the keycap 16 to return to an original position.

The light source 15 is disposed below the baseboard 14 and is configured to generate light to illuminate the key 11. The light source 15 includes an LED 151 and a light guide plate 152, and an upper surface of the light guide plate 152 has a microstructure 153. In addition, the LED 151 is located at one side of the light guide plate 152. After the LED 151 generates light, the light is transmitted in the light guide plate 152, and the microstructure 153 is configured to change a path of the light, so that the light leaves the light guide plate 152 and penetrates up through an opening 121 of the deckle board 12, and further illuminates the keycap 16 and makes the key 11 luminous.

Although the light source 15 of the conventional luminous keyboard 10 can illuminate the key 11, the light of the light source 15 easily leaks from the openings 121 of the deckle board 12, resulting in a halo generated around the keycap 16 and increasing visual interference. Therefore, how to resolve light leakage of keys becomes an urgent problem to be resolved. To resolve the foregoing problem, a luminous keyboard is needed to improve disadvantages of the conventional luminous keyboard.

### SUMMARY OF THE INVENTION

A main objective of the present invention is to provide a luminous keyboard preventing light leakage.

In a preferred embodiment, the present invention provides a luminous keyboard, including:

a light source;

at least one key, located above the light source, where the light source illuminates the key; and

at least one ring-shaped shading element, disposed between the light source and the key, where one end of the ring-shaped shading element close to the key is located at an inner side of the key and configured to shade light of the light source, and when the key is pressed down, the key presses down the ring-shaped shading element and enables the ring-shaped shading element to be deformed.

In a preferred embodiment, the ring-shaped shading element has an opening, so that the light penetrates through the opening and illuminates the key.

In a preferred embodiment, the key includes a keycap and a support structure, and the support structure penetrates the opening of the ring-shaped shading element and is connected to the keycap and supports the keycap.

In a preferred embodiment, the support structure is scissors.

In a preferred embodiment, the ring-shaped shading element is a shading element made of a flexible material.

In a preferred embodiment, the ring-shaped shading element is formed on a shading board.

In a preferred embodiment, the ring-shaped shading element is a shading element made of a non-transparent material, or a shading element made of a transparent material coated with a non-transparent coating.

In a preferred embodiment, the light source is a backlight module.

In a preferred embodiment, the luminous keyboard further includes a switch circuit board, located below the ring-shaped shading element and configured to generate a switch signal.

### BRIEF DESCRIPTION OF THE DRAWINGS

FIG. 1 is a schematic diagram of a conventional luminous keyboard;

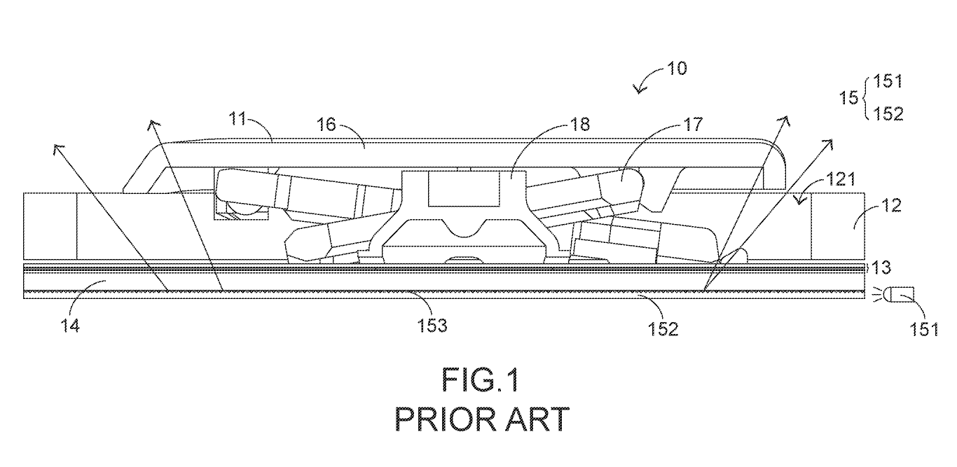

FIG. 2 is a schematic diagram of a luminous keyboard according to the present invention;

FIG. 3 is an exploded view of the luminous keyboard according to the present invention;

FIG. 4 is a sectional view of the luminous keyboard according to the present invention; and

FIG. 5 is a schematic diagram of pressing the luminous keyboard according to the present invention.

### DETAILED DESCRIPTION OF THE PREFERRED EMBODIMENT

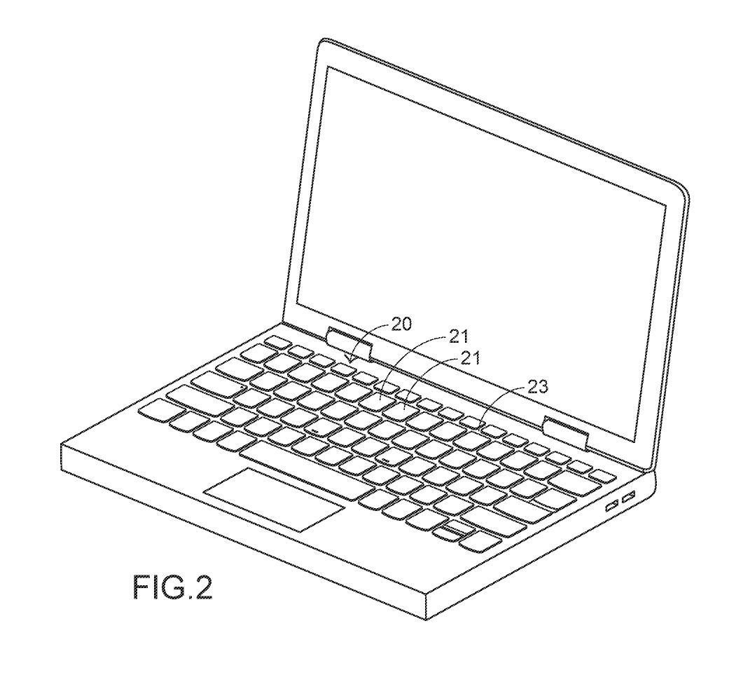

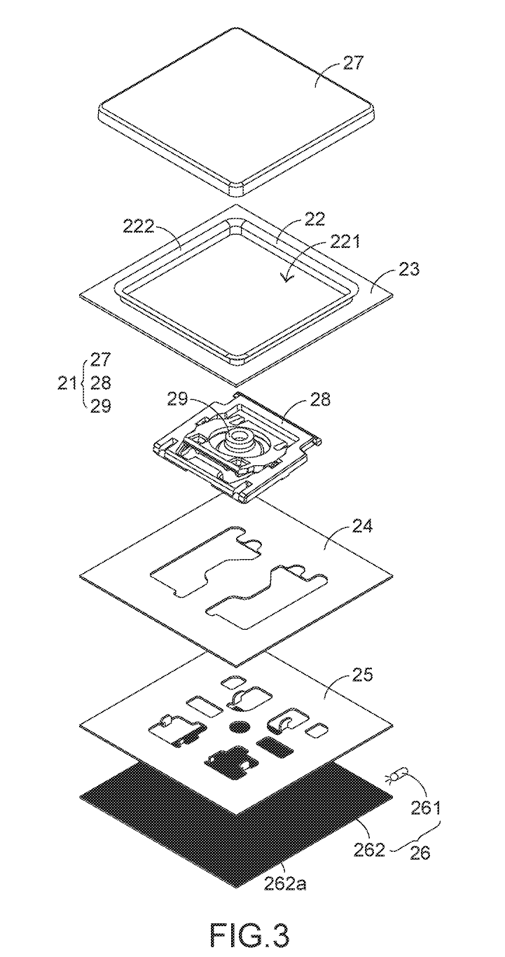

Referring to FIG. 2 and FIG. 3, FIG. 2 is a schematic diagram of a luminous keyboard according to the present invention, and FIG. 3 is an exploded view of the luminous keyboard according to the present invention. As shown in FIG. 2 and FIG. 3, the luminous keyboard 20 includes at least one key 21, a ring-shaped shading element 22, a shading board 23, a switch circuit board 24, a baseboard 25, and a light source 26. Each key 21 includes a keycap 27, a support element 28, and an elastic body 29, and the ring-shaped shading element 22 includes an opening 221.

The ring-shaped shading element 22, the shading board 23, the switch circuit board 24, the baseboard 25, and the light source 26 are sequentially disposed below the keycap 27 from top to bottom. One end 222 of the ring-shaped shading element 22 close to the key 21 is located at an inner side of the key 21 and configured to shade light of the light source 26, so that the light penetrates through the opening 221 of the ring-shaped shading element 22 and illuminates the key 21.

The ring-shaped shading element 22 may be an independent element, or may be formed on the shading board 23. An example in which the ring-shaped shading element 22 is formed on the shading board 23 is used below. The ring-shaped shading element 22 and the shading board 23 are integrally molded by using a same material or different materials. Alternatively, the ring-shaped shading element 22 and the shading board 23 are separately manufactured, and then the ring-shaped shading element 22 is fixed on the shading board 23 in common fixing manners such as adhesion, hot melting, and soldering.

The switch circuit board 24 is located below the ring-shaped shading element 22 and is configured to generate a switch signal. In this preferred embodiment, the switch circuit board 24 is a membrane switch circuit, and a membrane of the membrane switch circuit is a transparent membrane, so that the light can penetrate up through the membrane switch circuit. The baseboard 25 is located below the switch circuit board 24 and is configured to fix the key 21.

In this preferred embodiment, the luminous keyboard 20 has the shading board 23, and the shading board 23 may be, but not limited to, a deckle board of a keyboard. In another preferred embodiment, the luminous keyboard 20 may not be provided with a shading board, but the shading board is replaced by a board adjacent to the ring-shaped shading element 22. For example, a non-transparent coating is coated on a local surface of the switch circuit board 24, so that a part of the non-transparent coating has a light shading effect, and the light can penetrate through a part not coated with the non-transparent coating. In this way, the shading board can be replaced by the switch circuit board 24, and the ring-shaped shading element 22 may also be formed on the switch circuit board 24.

The light source 26 is disposed below the key 21 and is configured to illuminate the keycap 27 of the key 21. Because the ring-shaped shading element 22 is located between the key 21 and the light source 26, the ring-shaped shading element 22 can shade light generated by the light source 26 and prevent the light from leaking from a gap between the key 21 and another key 21. The ring-shaped shading element 22 may be made of a non-transparent material such as metal, or may be made of a transparent material coated with a non-transparent coating such as silica gel or Mylar. In this preferred embodiment, the shading board 23 is sheet metal. At least one protruding structure is generated on the sheet metal by means of a protruding process, and an opening 221 is provided at the top of each protruding structure, so that the light can penetrate through the opening 221 and illuminate the key 21, and the protruding structure having the opening 221 forms the ring-shaped shading element 22.

A method for combining and fixing elements of the key 21 is described below. As shown in FIG. 3, the support element 28 is disposed below the keycap 27 and is configured to support the keycap 27. One end of the support element 28 is connected to a lower surface of the keycap 27, and the other end of the support element 28 penetrates through the opening 221 of the ring-shaped shading element 22 and is further connected to a hook of the baseboard 25. Therefore, the keycap 27 is fixed on the baseboard 25 by means of the support element 28. In this preferred embodiment, the support element 28 is, but not limited to, scissors.

The elastic body 29 is disposed between the keycap 27 and the switch circuit board 24 and is configured to provide an elastic force for the keycap 27 to return to an original position. When the keycap 27 is pressed down, the elastic body 29 is pressed down by the keycap 27 to be deformed and accumulate elastic energy, and triggers the switch circuit board 24 to generate a switch signal. When the keycap 27 is not pressed down, the elastic body 29 releases the elastic energy to drive the keycap 27 to keep away from the baseboard 25 and return to the original position.

The light source 26 is disposed below the baseboard 25 and is configured to illuminate the key 21. In this preferred embodiment, the light source 26 is, but not limited to, a backlight module. In another preferred embodiment, the light source 26 may be a plurality of LEDs. The plurality of LEDs is disposed on the switch circuit board 24, and each LED is located below each key 21, and respectively illuminates each key 21.

An example in which the light source 26 is a backlight module is used below. The light source 26 includes at least one LED 261 and a light guide plate 262. The LED 261 may be disposed at one side of the light guide plate 262, or disposed in a through hole of the light guide plate 262. After light generated by the LED 261 enters the light guide plate 262, the light continuously performs total reflection in the light guide plate 262. Therefore, the light is evenly distributed in the light guide plate 262.

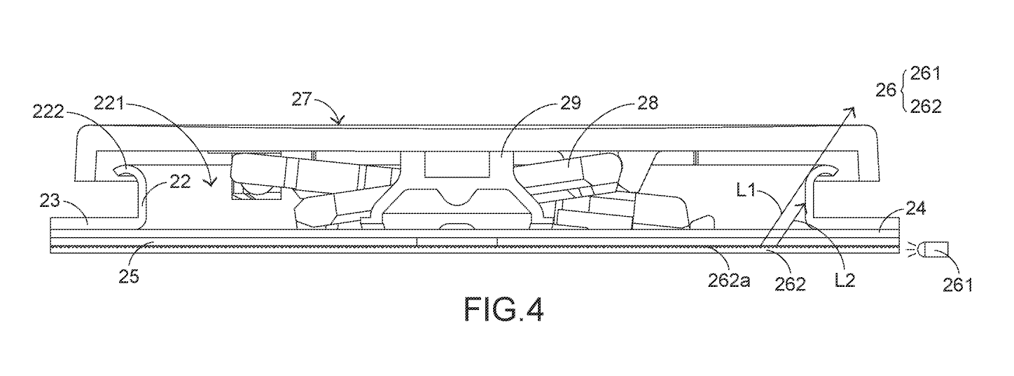

Referring to FIG. 4, FIG. 4 is a sectional view of the luminous keyboard according to the present invention. As shown in FIG. 4, after the light of the LED 261 enters the light guide plate 262, the light is evenly distributed in the light guide plate 262. When the light is affected by light guide ink or a microstructure 262a of the light guide plate 262 and a path of the light is changed, the light leaves the light guide plate 262 and penetrates up through a euphotic zone of a baseboard 25 (not shown in the figure). The euphotic zone of the baseboard 25 is, but not limited to, a loophole.

Later, the light continuously proceeds. Part of light L1 penetrates the switch circuit board 24 above the baseboard 25 and penetrates the opening 221 of the ring-shaped shading element 22, and then arrives at the keycap 27 and illuminates the key 21. In addition, because shaded by the ring-shaped shading element 22 and the shading board 23, a light emitting range of part of light L2 is limited, and the part of light L2 cannot be leaked from a gap between the key 21 and another key 21, thereby resolving a problem of light leakage. It may be known from above that a higher height of the ring-shaped shading element 22 indicates a better light-shading effect.

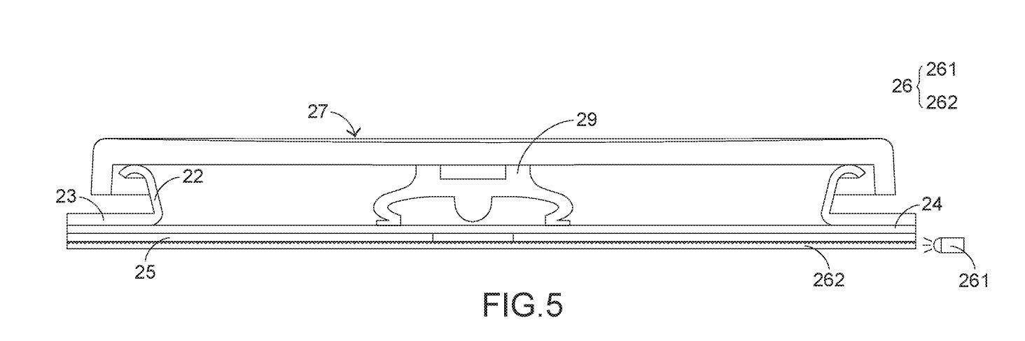

Referring to FIG. 5, FIG. 5 is a schematic diagram of pressing the luminous keyboard according to the present invention. Because the ring-shaped shading element 22 has a particular height, when the keycap 27 is pressed down, the keycap 27 will certainly contact the ring-shaped shading element 22. As shown in FIG. 5, when the keycap 27 is pressed down, the keycap 27 moves towards the baseboard 25 and presses down the elastic body 29 and the ring-shaped shading element 22.

To prevent the ring-shaped shading element 22 from affecting strokes of the key, the ring-shaped shading element 22 may be made of a flexible material such as metal, silica gel, or Mylar. Because the ring-shaped shading element 22 is flexible, when the keycap 27 presses down the ring-shaped shading element 22, the ring-shaped shading element 22 is deformed, but after the end of the stress, the ring-shaped shading element 22 may return to a shape before the stress.

It may be known from the description of the foregoing preferred embodiments that the luminous keyboard in the present invention has a ring-shaped shading element. In this way, the ring-shaped shading element prevents light from being leaked between a key and another key, and a problem of a light halo generated around a keycap is resolved. In addition, when the key is pressed down, the ring-shaped shading element pressed down by the key is deformed, and therefore, a pressing stroke of the key is not affected by the ring-shaped shading element.

The foregoing description is only preferred embodiments of the present invention, but is not intended to limit the claims of the present invention. Any equivalent replacement or modification made without departing from the spirit of the present invention shall fall within the claims of the present invention.

What is claimed is:

1. A luminous keyboard, comprising:
a light source;
at least one key, located above the light source, wherein the light source illuminates the key; and
at least one ring-shaped shading element, disposed between the light source and the key, wherein one end of the ring-shaped shading element close to the key is located at an inner side of the key and configured to shade light of the light source, and when the key is pressed down, the key presses down the ring-shaped shading element and enables the ring-shaped shading element to be deformed.

2. The luminous keyboard according to claim 1, wherein the ring-shaped shading element has an opening, so that the light penetrates through the opening and illuminates the key.

3. The luminous keyboard according to claim 2, wherein the key comprises a keycap and a support structure, and the support structure penetrates the opening of the ring-shaped shading element and is connected to the keycap and supports the keycap.

4. The luminous keyboard according to claim 3, wherein the support structure is scissors.

5. The luminous keyboard according to claim 1, wherein the ring-shaped shading element is a shading element made of a flexible material.

6. The luminous keyboard according to claim 1, wherein the ring-shaped shading element is formed on a shading board.

7. The luminous keyboard according to claim 1, wherein the ring-shaped shading element is a shading element made of a non-transparent material, or a shading element made of a transparent material coated with a non-transparent coating.

8. The luminous keyboard according to claim 1, wherein the light source is a backlight module.

9. The luminous keyboard according to claim 1, wherein the luminous keyboard further comprises a switch circuit board, located below the ring-shaped shading element and configured to generate a switch signal.
